(19) United States
(12) Patent Application Publication
(10) Pub. No.: US 2019/0306930 A1
(43) Pub. Date: Oct. 3, 2019

(54) INDUCTION HEATING AND COOKING

(71) Applicant: Lee Huang, Palo Alto, CA (US)

(72) Inventor: Lee Huang, Palo Alto, CA (US)

(21) Appl. No.: 16/011,898

(22) Filed: Jun. 19, 2018

Related U.S. Application Data
(63) Continuation-in-part of application No. 15/942,528, filed on Apr. 1, 2018.

(51) Int. Cl. H05B 6/12; H05B 6/06; H05B 6/36

(52) U.S. Cl. CPC H05B 6/129; H05B 2206/022; H05B 6/36; H05B 6/062

(57) ABSTRACT

An induction cooking device includes an induction heating tunnel that has a frame defining boundaries of a tunnel opening and an induction coil assembly that includes induction wire wound to form a parallel current array on a top and a bottom of the frame. The induction cooking device also includes a food heating induction cartridge into which food is placed for heating.

### BACKGROUND

Energy efficient appliances improve the energy efficiency in kitchens. Commercial kitchens and restaurants use gas for cooking because gas cooking tends to more efficient than use of electrical appliances for cooking. In recent years, induction cooking has received some traction, especially in hotels and airport facilities that require use of electricity to cook.

The heating element used for induction heating is a conductive coil. Current through the coil produces an oscillating magnetic field. The magnetic field is created along the axial direction of the coil. Cookware, such as a stainless steel or iron pot, or a stainless steel or iron pan, is placed in the center of the coil, oriented axially. The oscillating magnetic field produced by the coil induces eddy current within conductive material within the cookware. Due to the electrical resistance within the cookware, the induced currents will generate heat in the cookware, thereby heating up the cookware.

Induction coils are designed in a plane, typically in a donut shape, so that the magnetic field can be spread out to the bottom of the pot. Because of the donut shape, the heating area is in an annular shape leaving a cold region at the center. Currently, this effect is mitigated by using a composite base for cookware, for example, sandwiching an aluminum disc between layers of ferromagnetic material to spread the heat across the base of the cookware.

### BRIEF DESCRIPTION OF THE DRAWINGS

FIG. 1 shows an induction heating coil with a work piece in accordance with the prior art.

FIG. 2 shows a conventional induction heating coil for a cooktop in accordance with the prior art.

FIG. 3 shows a conventional induction heating coil used with cookware in accordance with the prior art.

FIG. 4 shows a linear current wire array and a return current array in accordance with an implementation.

FIG. 5 shows a linear current wire array with a magnetic shield sheet in accordance with an implementation.

FIG. 6 shows a circular induction wire array and a cookware in accordance with an implementation.

FIG. 7 shows a hexagonal induction wire array in accordance with an implementation.

FIG. 8 shows a circular induction wire array and a wok in accordance with an implementation.

FIG. 9 shows an induction cooking device in accordance with an implementation.

FIG. 10 shows a plate with a thermal couple in accordance with an implementation.

FIG. 11 shows a power verses cooking time profile of heating in accordance with an implementation.

FIG. 12 shows an induction cooking device in accordance with an implementation.

FIG. 13 shows an induction cooking device with two induction heating tunnels in accordance with an implementation.

FIG. 14 shows an induction cooking device where a food-heating induction cartridge can be rotated in accordance with an implementation.

FIG. 15 shows a food-heating induction cartridge in accordance with an implementation.

FIG. 16 shows a burger-heating induction cooking device in accordance with an implementation.

FIG. 17 shows a burger-heating induction cartridge in accordance with an implementation.

FIG. 18 shows a conveyor belt induction oven in accordance with an implementation.

FIG. 19 shows an induction oven in accordance with an implementation.

FIG. 20 shows a wall mount induction heater in accordance with an implementation.

### DESCRIPTION OF THE EMBODIMENTS

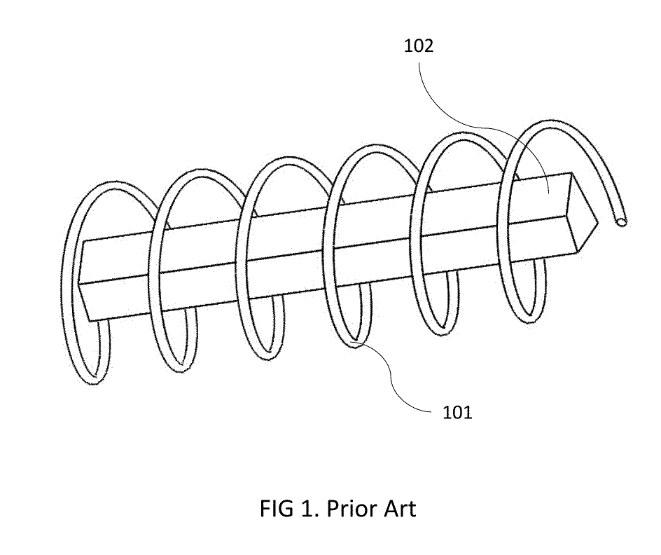

A typical induction heater set up is shown in FIG. 1 where current runs through an electrical coil 101, causing a magnetic field to be uniformly generated in the cylindrical space inside the coil along the axis of the coil. When the current is an alternating current, the magnetic field is time-varying. A workpiece 102 is composed of magnetic material, such as metal with iron content. When workpiece 102 is placed inside electrical coil 101, the time-varying magnetic field will generate eddy currents through the work piece. The eddy currents generate heat within the work piece.

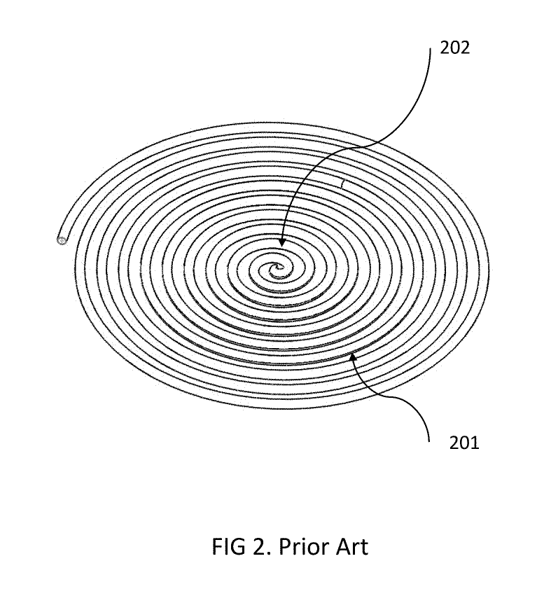

For an induction cooking device, the coil is arranged differently than a typical induction heater. The typical design of an induction heating coil 201 is shown in FIG. 2, where induction heating coil 201 is wound on a flat surface in a disc shape or donut shape. This shape allows induction heating coil 201 to induce eddy currents along a larger area. In this configuration, induction heating coil 201 creates magnetic field that is typically strong in the area where the wires of induction heating coil 201 are parallel, such as in area away from the center of induction heating coil 201 where the magnetic field from nearby currents are constructively superimposed. The magnetic field in a central area 202 of induction heating coil 201, where the nearby currents are opposing, is the weakest. As a result, a typical heating profile of an induction cooktop is annular. Such a pattern is inconvenient when cooking, as it is preferred to have an even heating surface. Hot spots can cause uneven cooking.

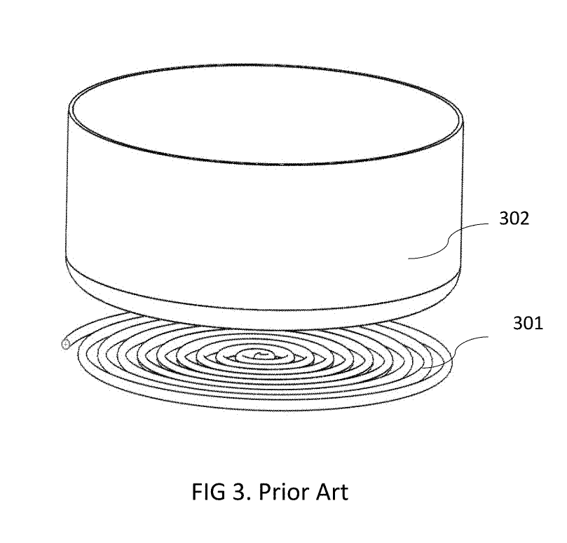

FIG. 3 shows induction ready cookware 302 placed on one side of a disc-shaped induction heating coil 301. In order to overcome the annular heating profile produced by a disc-shaped induction heating coil 301 cookware 302 can be produced in a multi-ply implementation of clad metal where, for example, a layer of aluminum is sandwiched between two sheets of stainless steel. The highly thermally conductive aluminum layer transfers heat laterally along sheets of stainless steel to evenly distribute the heat. For more even heating, a greater number of layers are used, such as a 5-ply system: steel-aluminum-steel-aluminum-steel. The uneven heating from induction is somewhat improved by these material systems. However, these material systems tend to be expensive and limited in area.

Using a disc-shaped induction heating coil, it is difficult to create a large uniform heating area such as is needed for griddle cooking. Further, using a composite metal plate to even out the temperature across the large area required by a griddle can be expensive.

However, as described below, it is possible to design an induction heating element that will eliminates temperature hot spots and provides an even heating surface for both industrial and foodservice applications. This is done, for example, by providing a first array of parallel current-carrying wires, oriented in the same direction and sufficiently closely spaced such that the wires effectively create a flat current sheet. Current through the flat current sheet induces a uniform magnetic field above the wire array. In order to form a closed circuit, there is a second array of return current carrying wires arranged under the first array of parallel current-carrying wires. Magnetic field shielding is placed between the first array of parallel current-carrying wires and the second array of return current carrying wires so that the magnetic field of the second array of return current carrying wires does not cancel out the magnetic field of the first array of parallel current-carrying wires. The result is a strong uniform magnetic field above the first array of parallel current-carrying wires, where cookware such as a griddle can be placed to be heat up uniformly.

Although the following detailed description contains many specifics for the purpose of illustration, anyone of ordinary skill in the art will readily appreciate that many variations and alterations to the following exemplary details may be made. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

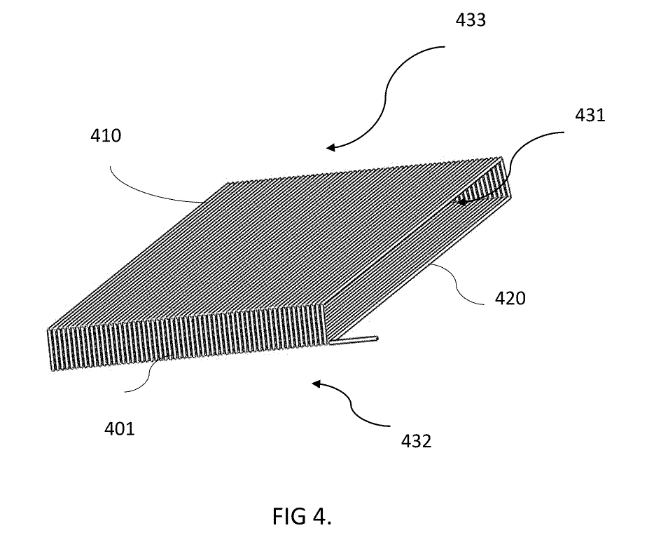

FIG. 4 shows electric induction wire 401 forming a helix shaped induction coil. In FIG. 4, electric induction wire 401 is arranged as a rectangular helix. The helix includes a first array of parallel current-carrying wires 410 and a second array of return current carrying wires 420. For the configuration of electric induction wire 401 shown in FIG. 4, when an electric current is running through electric induction wire 401, a magnetic field is generated and mainly distributed in a space 432 between first array of parallel current-carrying wires 410 and second array of return current carrying wires 420. The magnitude of the magnetic field is the sum of the magnetic field contributed from current in parallel current-carrying wires 410 and the current in second array of return current carrying wires 420.

The magnetic field generated in area 431 below second array of return current carrying wires 420 and in area 432 above first array of parallel current-carrying wires 410 is negligible because in these areas the magnetic effects of second array of return current carrying wires 420 and first array of parallel current-carrying wires 410 tend to cancel out.

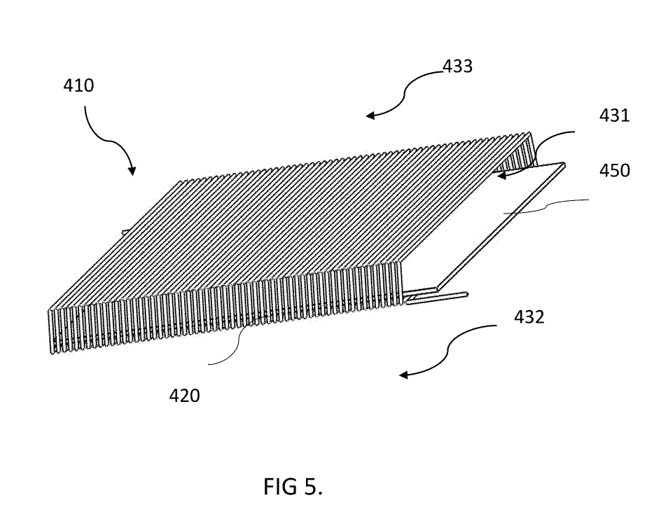

FIG. 5. shows a magnetic shielding sheet 450 between first array of parallel current-carrying wires 410 and second array of return current carrying wires 420. First array of parallel current-carrying wires 420 is composed of wires oriented in the same direction and sufficiently closely spaced such that the wires effectively create a current sheet.

The purpose of magnetic shielding sheet 450 is to separate the magnetic field generated from current through first array of parallel current-carrying wires 410 from the magnetic field generated from current through first array of parallel current-carrying wires 410 from second array of return current carrying wires 420. Magnetic shielding sheet 450 significantly reduces or eliminates the magnetic field cancellation that resulted in a negligible magnetic field in area 431 below second array of return current carrying wires 420 and in area 432 above first array of parallel current-carrying wires 410. When magnetic shielding sheet 450 is inserted between first array of parallel current-carrying wires 410 and second array of return current carrying wires 420, induction ready cookware placed in area 431 below second array of return current carrying wires 420 and in area 432 above first array of parallel current-carrying wires 410 will receive sufficient magnetic energy for cooking. For example, magnetic shielding sheet 450 contains a heat sink for heat dissipation.

For example, magnetic shielding sheet 450 has the properties of high saturation level and low eddy current density, leading to low power loss. With the combination of the thickness of the material and the saturation of magnetic shielding sheet 450, the magnetic field in space 432 generated from current in first array of parallel current-carrying wires 410 will not be affected much by the magnetic field generated from current in second array of return current carrying wires 420. If the magnetic field in space 432 is intended for induction cooking, it is preferable that magnetic shielding sheet 450 should be placed close to second array of return current carrying wires 420. The magnetic flux conductivity of magnetic shielding sheet 450 should match the total magnetic field flux generated from total electric current from second array of return current carrying wires 420. In this way the magnetic field distribution from current in the first array of parallel current-carrying wires 410 should be minimally affected by this shielding sheet.

Alternatively, two sheets of magnetic shielding can be used, one close to first array of parallel current-carrying wires 410 and one close to second array of return current carrying wires 420, so that the magnetic field can be concentrated near first array of parallel current-carrying wires 410 and near second array of return current carrying wires 420. Nevertheless, to minimize loss it is preferable to use a single sheet to redirect the magnetic field from second array of return current carrying wires 420.

An important property of magnetic shielding sheet 450 is low loss, so that loss resulting from the presence of magnetic shielding sheet 450 does not affect the overall efficiency of the induction cooking device. The loss in magnetic shielding sheet 450 includes hysteresis losses and eddy current losses. The hysteresis loss is due to the flipping of the domains of magnetic shielding sheet 450, which causes energy to be lost as heat. With proper selection of the material used to produce magnetic shielding sheet 450, it is possible to design an induction cooking appliance with minimum loss due to magnetic shielding sheet 450. If necessary, second array of return current carrying wires 420 and magnetic shielding sheet 450 can be mounted on a heat sink that dissipates the heat generated from resistive losses in electric induction wire 401 and the heat generated from the eddy current and hysteresis losses in magnetic shielding sheet 450.

In FIG. 5, the induction coil pattern of electric induction wire 401 is rectangular, forming a module unit that can be arrayed to provide induction cooking for a large area. In additional to rectangular units, it is possible to cover large areas using hexagonal units or a combination of other geographic shapes such as hexagonal, round, oval square or other geographic shapes. An induction coil pattern of electric induction wire can form a helix pattern that produces a first array of parallel current-carrying wires with any desired geometry suitable for induction heating.

For example, a first array of parallel current-carrying wires can have a geometry suitable for even heating of a griddle cooking appliance. A typical griddle has a rectangular surface area such as twenty-four inches by twenty-four inches, or forty-eight inches by forty-eight inches. An array of induction cooking elements such as first array of parallel current-carrying wires 410 can be used to cover an entire griddle, resulting in a griddle appliance with uniform heating without the need for multi-ply surfaces. This is helpful as for a large griddle implemented using a tri-ply construction of the griddle surface, the layers tend to be thin, and this tends to warping in a griddle application. Using explosion bonding to obtain thicker multi-ply composite metal constructions is expensive.

A typical griddle plate is a one-half inch to one-inch thick steel plate. When using first array of parallel current-carrying wires 410 or a similar uniform heating wiring array, it is possible to use a thinner griddle plate because with the uniform heating provided by first array of parallel current-carrying wires 410, the chance of warping is reduced.

For example, first array of parallel current-carrying wires 410 is used to implement one modular element in an array of modular elements. In such an array, it is preferable to be able to control the induction power to each individual modular element. When a temperature sensor is installed in each modular element to sense the temperature of the cookware at the area of the modular element, it is possible to provide power to each modular element accordingly. For example, when a cold piece of meat is place in area of a griddle, the local temperature of the griddle metal plate will drop. The dropping of the temperature locally can contribute to warping of the metal plate. Therefore, it is desirable to for a griddle plate to increase the power to a modular element that heats that cold area, without increasing the temperature of other areas of griddle plate not loaded with cold meat. Such individual control of the modular elements improves overall energy efficiency of griddle cooking and reduces the chance of warping the griddle plate, which improves the useful life of the equipment.

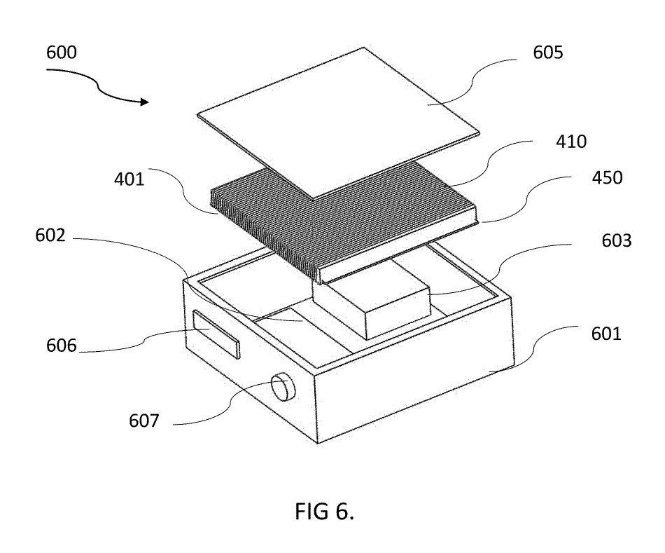

FIG. 6 shows a cooktop assembly 600 that includes a case 601 made, for example, of stainless steel. A circuit board 602 and a power supply 603 are within case 601. Helix-shaped electric induction wire 401 is placed so that first array of parallel current-carrying wires 410 is under a cooking griddle plate 605. Magnetic shielding sheet 450 is within helix-shaped electric induction wire 401 under first array of parallel current-carrying wires 410. In operation, the power level and the temperature of the steel plate 605 will be showed on a display 606 and can be controlled by turning a dial 606. Temperature of griddle plate 605 will be uniform which is ensured by the uniform wiring format of first array of parallel current-carrying wires 410. The size of case 601 and griddle plate 605 can be made to be a multiple of the size of first array of parallel current-carrying wires 410 in length and in width. In this case, multiple modular elements, each with its own array of parallel current-carrying wires is used to heat the large area griddle with uniform temperature with the ability of individually control current to each of the multiple modular elements to handle situations when food load is in some portion of the griddle area.

In addition to cooking, another application of induction heating can be for heating up sheet metal after painting to help the paint set. Using induction to induce eddy currents within the sheet metal can lead to better finish quality than is provided by heating the paint using a heat lamp. Also, providing heat via induction to the sheet metal helps strengthen the bond between paint and metal.

In wok cooking, it is vital that the center of the wok is hot. This is the opposite to the donut pattern resulting from conventional induction cooking devices. This makes it challenging for chefs to use induction heating when cooking with a wok. Some chefs adapt to induction wok cooking by scooping oil from the center area to the ring area to heat up the oil quicker.

As described above using a first array of parallel current-carrying wires created from a helix-shaped induction coil wired as described above can provide for induction heating where a heated central area is the hot area for cooking, as is provided by a conventional gas burner wok range.

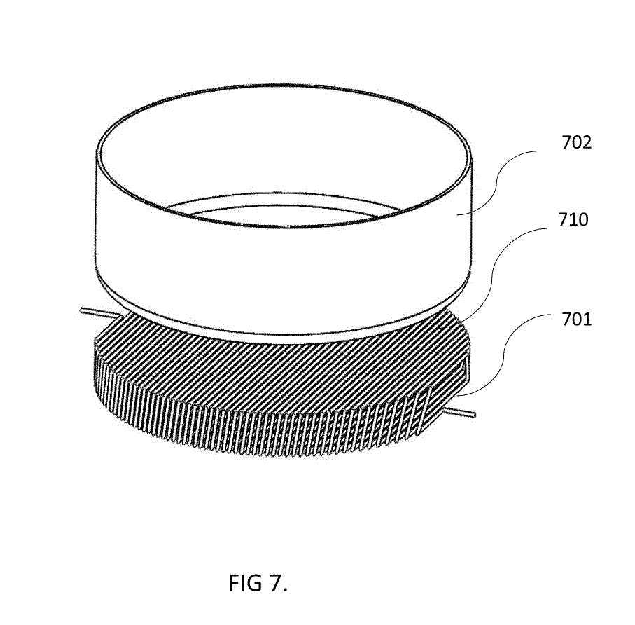

For example, FIG. 7 shows electric induction wire 701 patterned in a circular design to provide a first array of parallel current-carrying wires 710 for heating. Alternatively, a hexagonal pattern or a pattern of another geographic shape can be used for a cooktop assembly.

First array of parallel current-carrying wires 710 provides a uniform heating pattern that provides heat in the center area of a burner. When cookware 702 is placed closed to first array of parallel current-carrying wires 710 heating is uniform across the bottom of cookware 702.

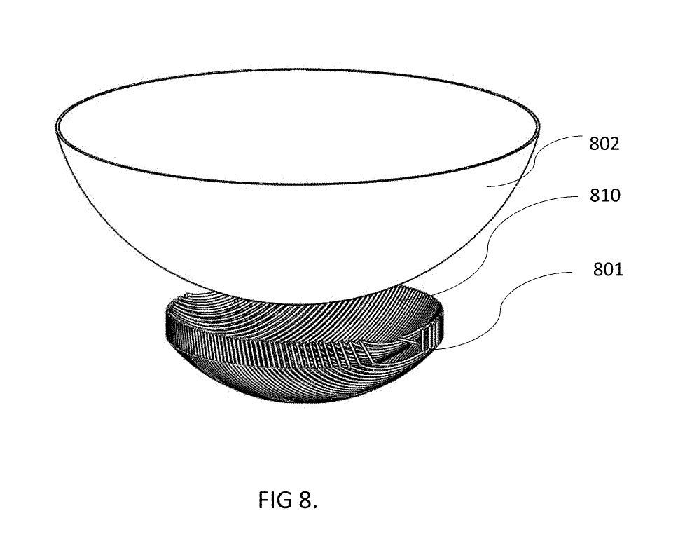

FIG. 8 shows how electric induction wire 801 is patterned in a circular design optimal for heating a wok. First array of parallel current-carrying wires 810 forms a concave top surface where the center portion of first array of parallel current-carrying wires 810 is recessed to conform the shape of first array of parallel current-carrying wires 810 to the bottom curvature of a wok 802. This eliminates the cold spot that results from use of conventional inductive elements. To further optimize first array of parallel current-carrying wires 810 for cooking with a wok, the parallel line pattern of first array of parallel current-carrying wires 810 can be shaped in an hour glass pattern where wires in the middle area have closer wire spacing. The closer wire spacing increases the magnetic field intensity in the middle area and thus increases heating generated at the center of the wok. This concentration of heating in the center of the wok mimics the hot center area in the conventional gas cooking wok range.

In the examples above, electric induction wires are arranged so that the resulting first array of parallel current-carrying wires is arranged as a single layer. However, multilayer current coils can be used to increase the strength of the induction magnetic field and therefore increasing the power delivered for heating.

As illustrated FIG. 4, the expansion of the current coil from a cylindrical configuration to a rectangular configuration expands surface area 432 and 433 with uniform magnetic field. Such expansion also results in a larger space inside the coil resulting an expanded uniform space inside the coil where the magnetic field is very uniform.

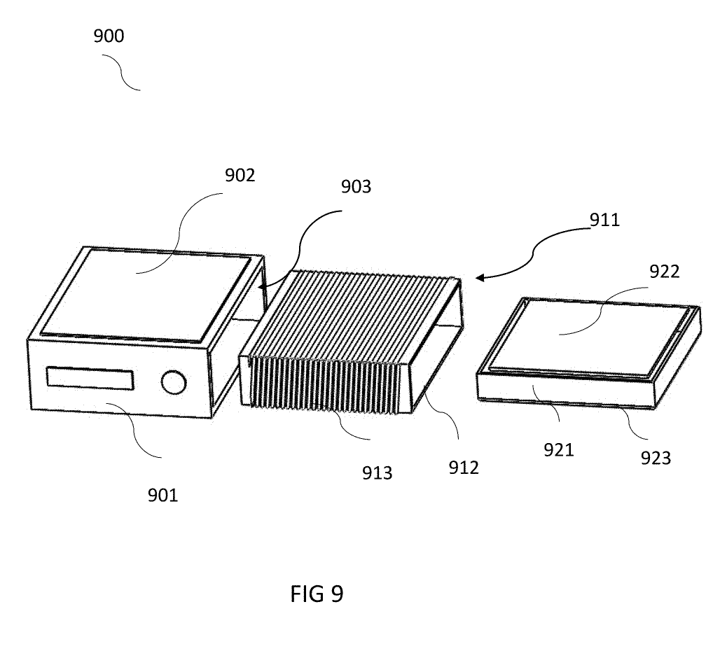

To further take advantage on the uniform magnetic field generated by the structure in FIG. 4, a food-heating induction cartridge can be added. An example of such a food-heating induction cartridge is shown in FIG. 9.

FIG. 9 shows an induction cooking device 900. A case 901 is rectangular in shape with an open cavity 903. Open cavity 903 extends through case 901. Open cavity 903 houses an induction coil assembly 911. Induction coil assembly 911 has a rectangular design and includes a frame 912 upon which induction wire is wound to form a parallel current wire array on the top and the bottom of frame 912. The space within frame 912 forms an induction heating tunnel which defines a maximum size of the volume of the food to be cooked. An induction heating tunnel is a longitudinal tube structure that holds a current coil and a coil array assemble. Inside an induction heating tunnel, a food-heating induction cartridge can heat up under the influence of alternating magnetic field generated by current through the current coil. For example, a tube of nonmagnetic material is used to support the winding current coil. Because the food-heating induction cartridge heats up inside the tube, it is preferable the tube is thermal insulated or has a layer of thermal insulating so that the current coil will not be overheated by heat generated inside the tube. Because the resistance of a current coil typically increases with temperature, heating of the current coil can result in higher energy loss.

The space within the induction heating tunnel magnetic field is uniform, intense and beneficial for cooking, especially where uniform heating is required. The uniformity of the magnetic field is ensured by the large ratio of length to width of the induction heating tunnel. Preferably the ratio is larger than one. A food-heating induction cartridge 921 is constructed of induction material that heats up when placed within an alternative magnetic field. Food-heating induction cartridge 921 is loaded with food and is placed inside the induction heating tunnel to be heated up by a uniform magnetic field. The heat generated in food-heating induction cartridge 921 is transferred to cook the food inside food-heating induction cartridge 921. To reduce the magnetic field leakage external to inducting heating tunnel, it is preferable to provide a magnetic shielding layer 902 outside the current coil. For example, the magnetic shield layer can be a foil tube or can consist of an array of magnetic bars.

For example, food-heating induction cartridge 921 includes a top plate 922 and a bottom tray 923, both made of induction material such as grade 430 stainless steel. For example, top plate 922 is hinged to tray 923 and a spring clip on tray 912 holds food by a clamping force. Preferably, top plate 922 is smaller than tray 923 so that the weight of top plate will rest on food placed on tray 923. Top plate 922 and tray 923 both apply heat to food allowing the food to cook faster than a normal cooktop cooking process where heat is coming only from the bottom of a pot. Because the heat generated during the cooking goes upward, it is preferable to have better thermal insulation on the top portion of the induction heating tunnel to minimize the temperature rise in the current coil. Additionally, or alternatively, a fan is used to draw air through a gap between the food-heating induction cartridge and the ceiling of the induction heating tunnel, so that the upper coil will can be kept at a preferred operating temperature.

Alternatively, instead of using a food-heating induction cartridge, a magnetic shield plate, as mentioned above, is placed inside open cavity 903 to decouple the magnetic field generated from the two current flow sheets. Without the interference from the magnetic field from the bottom current array, the magnetic field generated from sheet current in the top current array will present in the space above the top plate 920 of the induction cooker. An induction ready cook pot can be put on top of the plate 920, to perform conventional induction cooking.

Open cavity 903 is created by winding current coil on a rectangular tube to produce the induction heating tunnel. The rectangular tunnel shape expands in a direction perpendicular to the axial direction, making the induction heating tunnel a suitable location for heating food with the rectangular block shapes. The rectangular food-heating induction cartridge configuration is suitable for holding hamburger patty, steak, bread, pan cakes, or wafer of some sort. It is also good for cooking food with less even height, such as chicken thighs. The magnetic field induced by the top and bottom uniform current array will heat up and cook the food efficiently. The weight of the top plate will ensure constant contact between the top plate and a piece of meat. It is also preferably to position a food-heating induction cartridge in the middle of the space between the top current array and the bottom current array. The design of the food-heating induction cartridge will allow the magnetic field to reach the top and bottom induction heating plates evenly.

The opening of open cavity 903 can be through all the way to the back side of case 901, so that a fan can be installed on one side of the case to vent out the fumes from cooking of meats. For example, a built-in fan extracts fumes from cooking. For example, a built-in filter filters unwanted contents extracted from air flow before release outside case 901. For example, an electronic control unit is built-in to control the power to the food-heating induction cartridge to cook the contents.

For example, a typical recipe to cook a hearty steak is to have a good sear on both sides of the steak to seal the flavor of the beef. The sear is performed using a frying pan over a gas or electric stove. After searing, the steak is placed in an oven to finish the cooking of the beef to the desire doneness. It is a multistep, and multi appliance cooking process.

Using an induction heating tunnel, as described above, a heating sequence can be pre-programmed to heat beef sufficiently to a provide good sear, and then to lower heating power to cook the beef a right length of time for desired doneness. Such programming allows this cooking to be done with one simple one touch of a button.

For example, a control circuit controls the current flow through induction wiring, and a sensor is used to sense the temperature of the food-heating induction cartridge. For example, the sensor is implemented using a thermal couple or infrared (IR) temperature sensor.

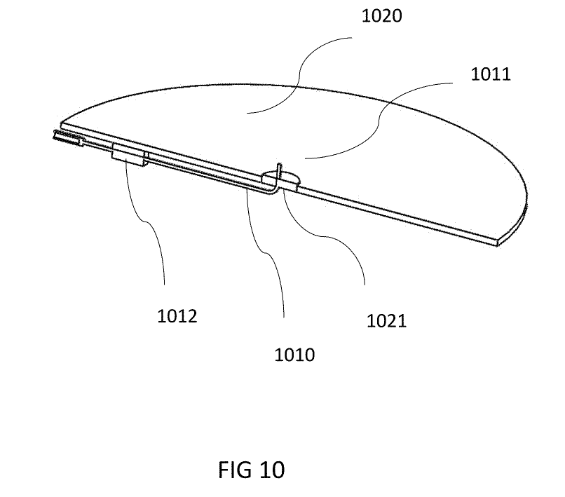

Often it is desirable to be able to directly sense the temperature of meat within a food-heating induction cartridge. As shown in FIG. 10, a thermal couple 1010 is installed on a plate 1020 of a food-heating induction cartridge. A tip 1011 of thermal couple 1010 is pointing up so that tip 1011 can poke in meat placed in the food-heating induction cartridge. The length of thermal couple 1010 between tip 1011 and a mounting block 1012 is long enough so that temperature is not increased at tip 1011. That is, the thermal junction of the thermal couple is heated mainly from the heat transfer from the meat around tip 1011 instead of heat conduction from the induction plate via a mounting block. Also, thermal couple 1010 feeds through a hole through plate 1020 and is held by a thermal insulating block 1021 that fills the hole through plate 1020.

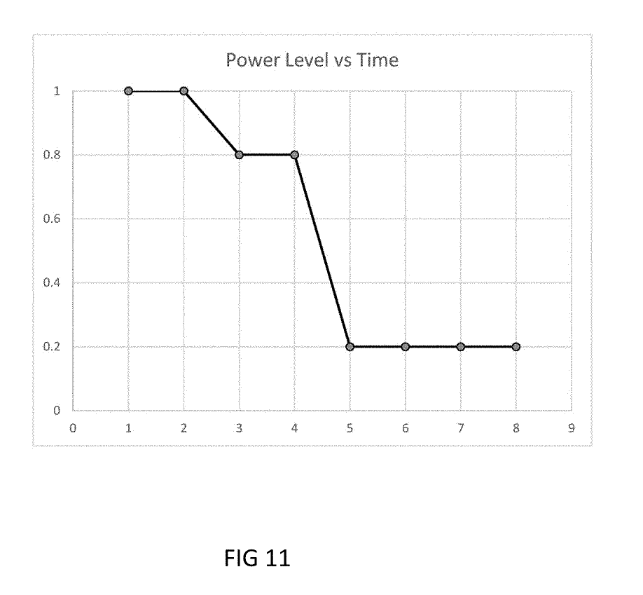

Power supplied to the induction cooker can be controlled by a controller according the desired temperature of the food, and time of cooking according to a recipe tailored to the type of food being cooked. For example, a power verses cooking time profile of heating is shown in FIG. 11 for cooking steak.

As shown in FIG. 11, at the beginning of the cooking profile, in a time period between time mark 1 and time mark 2, power is high to raise the temperature of a food-heating induction cartridge in order to achieve the best sear on the surface of a steak. After the initial searing, the power will drop to a lower level from time mark 3 to time mark 4 to continue cooking. The power from time mark 3 to time mark 4 is 0.6 of the peak power. For example, this is high enough to continue to drive the heat to the center of the food without overly scorching the surface of the food. After time mark 4, the food is almost done, so the power will drop to a warm level until time mark 5. The cooking may still happen from time mark 4 to time mark 5 to complete the cooking to the desired amount of doneness. From time mark 5 and the food will be kept at suitable temperature for serving while incurring a minimum amount of extra cooking. A control system can be trained to achieve the right amount of cooking for a given recipe allowing for minimization of cooking time, efficiently achieving optimal quality.

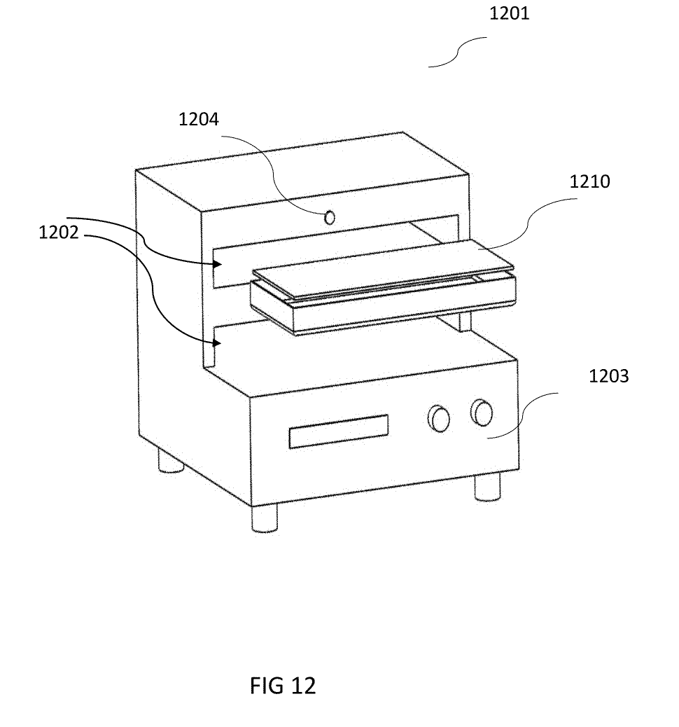

A food-heating induction cartridge can be configured for a single food item such as a piece of steak and/or can be configured to cook multiple items. For example, FIG. 12 shows an induction cooking device 1201 that has two built-in induction heating tunnels 1202. For example, the tunnel opening for each of induction heating tunnels 1202 is twenty-two inches by four inches. The channel length/depth is about thirteen inches. The wiring for each induction heating tunnel is located inside a case 1203 that houses the induction heating tunnels. The parallel lines of the wiring are along the width of the tunnel opening for induction heating tunnels 1202. For example, a food-heating induction cartridge 1210 is shaped as a long pan about twelve inches by twenty-one inches in size. For example, a few pieces of chicken can be fit in food-heating induction cartridge 1210 for cooking. The cooking is done from both top down and bottom up. For example, two handles can be put on a side wall of food-heating induction cartridge 1210 for easy handling. There is a power control unit in a lower portion of case 1203. Power display and control dial are on case 1203. For example, a light emitting diode (LED) indicator 1204 is located above each induction heating tunnel to indicate a cooking status in the respective induction heating tunnel. For example, the LED indicator turning red means cooking in the induction heating tunnel. The LED indicator light turning green means the cooking is done and the induction heating tunnel is in temperature holding mode. The LED indicator turning yellow means the cooking is done and not in temperature holding mode with power off. For example, a fan on the back of the induction cooking device pulls out cooking fumes and a filter is used to filter out the cooking related particulates before discharge to the environment.

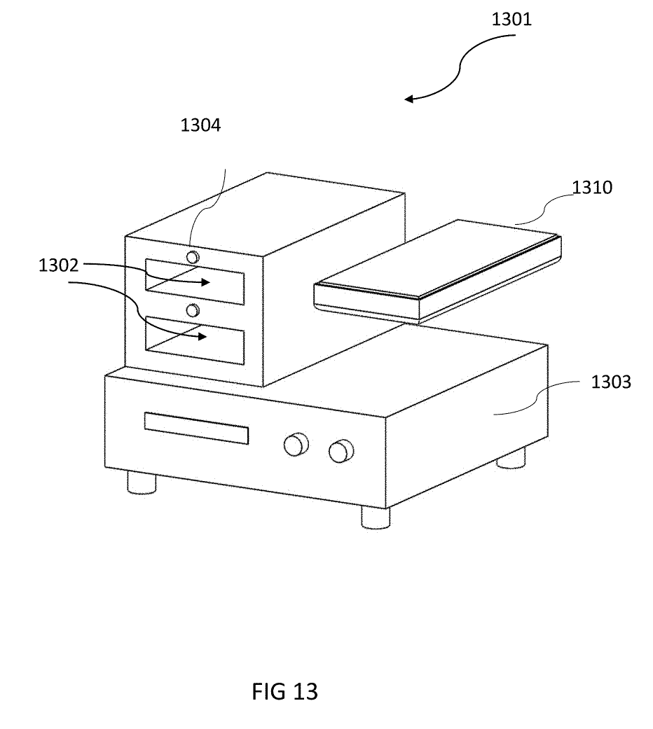

FIG. 13 shows induction cooking device 1301 that has two induction heating tunnels 1302. For example, each of induction heating tunnels 1302 has an opening about twelve inches by four inches. The depth of each induction heating tunnel is twenty-two inches. A food-heating induction cartridge 1310 is, for example eleven inches wide, four inches high and twenty-two inches long. Food-heating induction cartridge 1310 can be loaded with food and then slid into one of induction heating tunnels 1302 for cooking. A control circuit in a case 1303 controls the power profile to an induction coil inside the case. A light emitting diode (LED) light indicator 1304 is red when cooking is in process and turns green when the cooking is done. Induction cooking device 1301 can perform a cook and hold function. Magnetic field uniformity of induction cooking device 1301 is more uniform than magnetic field uniformity of induction cooking device shown in FIG. 12. Because the magnetic field inside induction heating tunnels 1302 is more concentrated than for induction cooking device shown in FIG. 12, it is expected that induction cooking device 1301 is more efficient. For example, induction cooking device 1301 includes a fan system to extract cooking related fumes and heat from induction heating tunnels 1302 to ensure current coils are within a functioning temperature range. For example, a filtration system is installed to remove the cooking related contents in the airflow before discharge to the environment.

When heating meat from top and bottom in a food-heating induction cartridge, juice from the meat drips downward while the heat goes upward. To give the cooked meat a more uniform appearance, the food-heating induction cartridge can be flipped. This is similar to flipping a burger patty and steak on a frying pan or on a griddle plate.

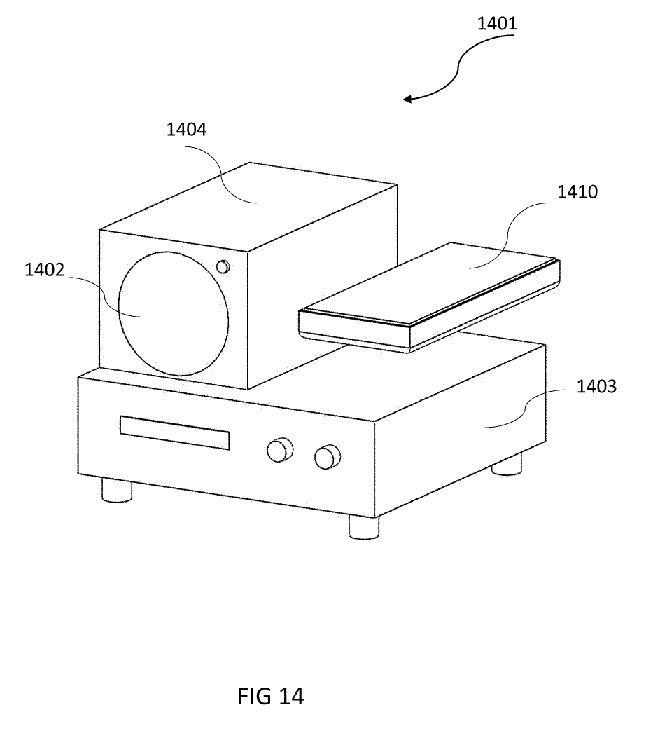

For example, FIG. 14 shows an induction cooking device 1401 including a case 1403 where a food-heating induction cartridge can be rotated inside an induction heating tunnel. Induction cooking device 1401 has a circular induction heating tunnel 1402 where an electric current coil winds around circular induction heating tunnel 1402 to create uniform magnetic field inside the induction heating tunnel. Food-heating induction cartridge 1410 can be loaded with food and placed in circular induction heating tunnel 1402 using a mechanism that allows spinning of a food-heating induction cartridge 1410 along an axis of circular induction heating tunnel 1402. It is possible to have the cooking done half of the time with lid side up, and half of the time with lid side down. Also, it is possible to control food-heating induction cartridge 1410 to spin continuously during the cooling process. An LED indicator 1404 is red when cooking is in process and turns green when the cooking is done.

For example, food-heating induction cartridge 1410 is made of induction ready material such as grade 430 stainless steel to allow heat up by alternating magnetic field. Because the magnetic field inside circular induction heating tunnel 1402 is uniform, the heating on the food cartridge will be uniform making it superior to the conventional donut shape of a heating element. It is especially beneficial for liquid food and food that spread out to the whole area of food-heating induction cartridge 1410. For example, food-heating induction cartridge 1410 is a pan. For solid food that does not fill the whole area in food-heating induction cartridge 1410, it is not advantageous to heat up the whole food-heating induction cartridge 1410. It is advantageous to heat up only the area within food-heating induction cartridge 1410 where the food is placed.

To improve the heat uniformity, clad metal is used where aluminum is sandwiched between two stainless steel sheets to spread heat. It is possible to make a plate with aluminum which can help spread the heat. Induction heating metal pads can be pressed on to the aluminum at the location where food is going to be placed. The induction heating metal pads can be in the shape of the food to be cooked.

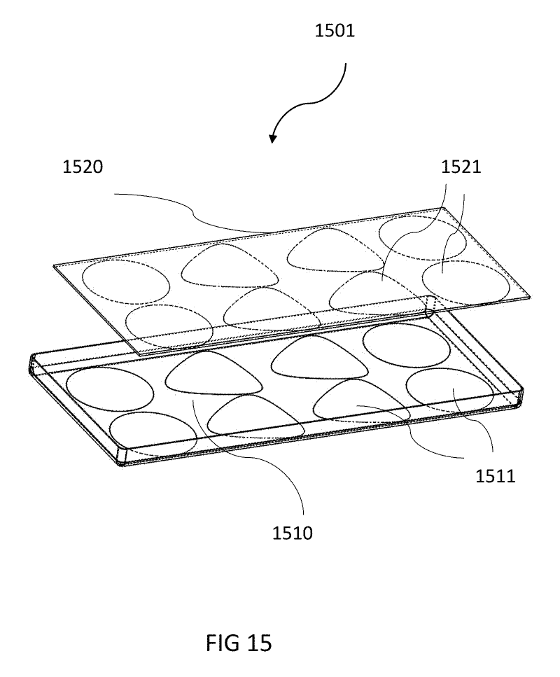

FIG. 15, shows a food-heating induction cartridge 1500 consists of a pan 1510 and lid 1520. Pan 1510 and lid 1520 are made of aluminum. Heating pads 1511 and heating pads 1521 are placed in locations where food is to be placed. Heating pads 1511 are bonded to pan 1510 either from inside pan 1510 or from outside of pan 1510. The ‘triangle shape’ of Heating pads 1511 are shaped to cook chicken thigh, T-bone steak and so on. A round shape is used for a burger patty. To avoid overheating locally, it is recommended that the food is loaded to every heating pad of the food-heating induction cartridge. Using heating pads is more efficient because there is less heat loss due the heating up areas where food is not present. Also, because the induction heating is very intense, heating up areas without food can result in extremely high temperatures in causing warping of food-heating induction cartridge or cookware.

The presence of a food cartridge where the magnetic heating element is magnetic in nature (For example, where the magnetic heating element is composed of stainless steel 430), will change the magnetic field distribution inside the space of the coil. It is preferable to have the all the magnetic field flux conducted in the heating element. Because the heating intensity is proportion to the magnetic field strength inside the heating element, the geometry of the magnetic heating element of the cartridge is designed to obtain temperature uniformity over the food cartridge, or more specifically, over the food contacting area of the cartridge. Besides geometric consideration, it is also important that the magnetic field saturation flux level of the magnetic heating element matches the intended heating uniformity. For example, the thickness of the heating element should not be so thick so that the magnetic field to be distribute evenly across the width of the heating pad. It is preferable to have half of the magnetic field flux pass through the top heating pad and half of the magnetic flux pass through the low heating pad and the magnetic field passes the pad evenly across the width of the pad. The magnetic field inside the tunnel is not completely uniform. That is, as measured along the length of the tunnel, the magnetic field is stronger in the middle of the tunnel. As measured along a cross section of the tunnel, the magnetic field is weaker in the center area of the tunnel.

It is possible to use a pattern perforated feature on the heating element complementary to the magnetic field distribution to obtain a uniform thermal profile. For example, the high magnetic field area has a high density perforated feature. The perforated feature can be simple round holes, or elongated voids. The holes and voids can be filled with aluminum, ceramic and other non-magnetic materials making the heating element a composite material structure.

To create a grill mark, a preselected pattern on the heating pad can be used to show the restaurant's logo, a special message or just simple a parallel grill mark. The protruded pattern can help make scorch mark on meat such as a steak or a burger.

Hamburger is a popular modern fast food. Cooking hamburgers efficiently allows for energy savings and better service for consumers. A food-heating induction cartridge can be used to cook a burger patty similar to cooking a steak. For example, a burger patty-oriented design is used. The temperature profile of the power to cook a burger patty is similar to the power profile for cooking steak. In a restaurant setting, burger patties are typically cooked on a griddle equipment to cook in a batch. It takes a large griddle plate with a top and bottom heating element to speed up the cooking; however, it is a conventional griddle configuration with high energy consumption.

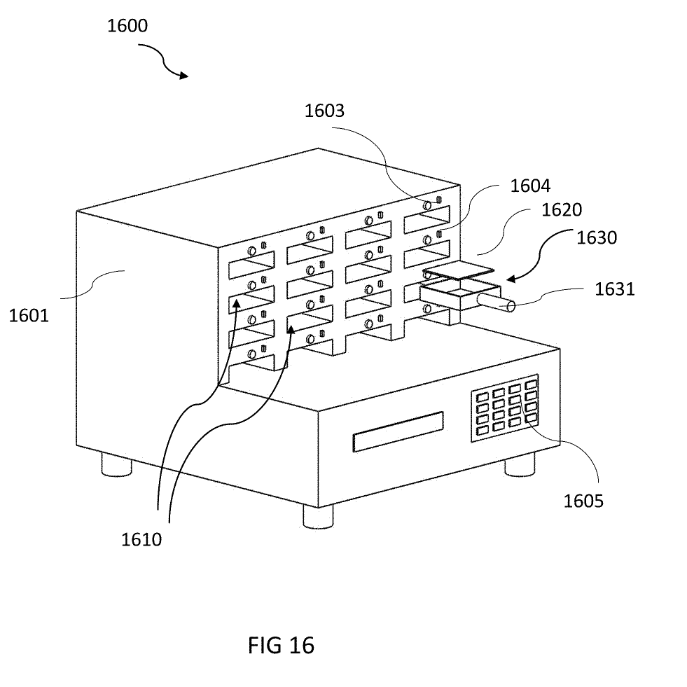

For example, FIG. 16 shows a burger-heating induction cooking induction cooking device 1600 that has a case 1601 with induction heating tunnels 1610 forming shelves like a mail box. Each of induction heating tunnels 1610 has a current coil configured as a rectangular shape such as those shown in FIG. 4. Each of induction heating tunnels 1610 is designed to house a food-heating induction cartridge for a burger patty. For a patty size of about four inches in diameter and 0.5 inches thick, the opening for each of induction heating tunnels 1610 is about five inches by two inches.

An induction heating food cartridge for a patty is composed two pieces. A first piece is a pan 1630 made of induction ready stainless steel with an induction ready metal plate. Alternatively, pan 1630 is an aluminum pan with induction pad of the same diameter of the bottom of pan 1630 embedded either inside or outside of the bottom of pan 1630. For example, the induction pad of pan 1630 consists of an array of pads. For example, the induction pad of pan 1630 has a first pattern of perforations selected to achieve uniform heating under influence of an alternative magnetic field.

A second piece is a lid plate 1620 used as induction heating element from the top. For example, lid plate 1620 is made of induction ready stainless steel with an induction ready metal plate. Alternatively, lid plate 1620 is an aluminum plate with induction pad embedded on either side. For example, the induction pad of lid plate 1620 consists of an array of pads. For example, the induction pad of lid plate 1620 has a first pattern of perforations selected to achieve uniform heating under influence of an alternative magnetic field.

Lid plate 1620 can be connected to pan 1630 by a hinge. The hinge is loosely attached so that the weight of lid plate 1620 can ensure lid plate 1620 rests on the food that is in pan 1630. The hinge can be a tong type configuration with two flat holding induction metal pieces and with a clip lock mechanism to hold the food in between the two holding pieces. A handle 1631 is connected to pan 1630.

A control unit inside case 1601, provides power to the array of induction heating tunnels. The power supplied to each induction heating tunnel has a similar profile to the temperature profile shown in FIG. 11. A power splitter is used to split the power to each induction heating tunnel. Due to the nature of the power curve requirement, it is possible to sequentially provide power to the induction heating tunnels to reduce the peak power needed from the power supply. For example, the timing of the power is offset to two induction heating tunnels such that the peak power to the second induction heating tunnel is staggered to be at different time than peak power to the first induction heating tunnel. Some power staggering may also occur based on different loading times of patties into food-heating induction cartridges.

Control circuitry is used to sense the loading of a patty cartridge into an induction heating tunnel in order to automate heating time start. An operator can just keep loading the array of induction heating tunnels and the cooking is performed automatically. Sensing is done, for example, by sensing the capacity of the food-heating induction cartridge with and without food, or by using other physical parameters. LED indicators 1603 for each induction heating tunnel are used to tell the operator if the patty is done in that induction heating tunnel. When the patty is done, the LED light will turn green. The operator can take the burger patty out from the food-heating induction cartridge and put the empty food-heating induction cartridge back into the induction heating tunnel. For example, induction cooking device 1600 senses whether a food-heating induction cartridge is empty or not. When an operator places an empty patty cartridge in an induction heating tunnel, the LED light for the induction heating tunnel will be yellow and no power or minimum power is applied to the empty patty cartridge. Alternatively, to keep the patty cartridge at a suitable temperature, the patty cartridge is warmed. The ability of such system to hold temperature after the patty is cooked reduces an operation step to move the patty from a cooking station to a holding station and reduces the need for an equipment space for holding equipment.

For example, a switch 1604 at each induction heating tunnel allows an operator to switch off that induction heating tunnel when the work load of the day is low. Instead of using a switch 1604, a control panel 1605 can be used to control power to each induction heating tunnel.

For example, for each induction heating tunnel, a switch can have several positions to indicate the weight category of the food put in the induction heating tunnel. For example, if a chicken thigh sizes are categorized into three groups (heavy weight, medium weight and light weight) a switch for each induction heating tunnel includes corresponding toggle positions so that an operator can indicate the weight of the food placed in the induction heating tunnel for cooking. Alternatively, a button array by each induction heating tunnel can be used instead of a toggle switch. Alternatively, this functionality can be programmed using control panel 1605. Recipes can be stored inside the programmer for ease of use of the equipment.

For example, exhaust fans are installed at the back of the induction heating tunnels to draw out the fumes created in the cooking process. Also, a filter system is used to clean out the exhaust flow before discharge to the environment. The speed flow of the exhaust system can be controlled according the number of burger patties being cooked and the stage of the cooking of the burger patty so as to optimize the energy consumption of the system.

Different temperature profiles can be programmed to optimize cooking for different recipes to vary the amount a burger patty is cooked or the crunchiness of the bread and so on. In order to take into account different degrees of the softness of cheeses the temperature holding profiles can be varied. This can allow induction cooking device 1600 to both cook and hold burger patties. This improves the energy efficiency on cooking a burger patty and eliminates the need to move a patty from a cooking station to a warming cabinet, eliminating the requirement to have warming cabinet and to have space for the warming cabinet. Because real estate in any restaurant establishment is a premium, it is a great help to eliminate the amount of required equipment.

The design of such a multi-tunnel cooking system can be modular. For example, multi-tunnel cooking system can include a basic four-tunnel model for a restaurant where burgers are not the major selling items on the menus. For restaurants where burgers are more substantially sold modularity can be increased, for example to a four by eight tunnel cooking system. A floor standing unit can be used. Such multi-tunnel cooking stations can also employ the traditional induction donut shape coils to work with induction heating food cartridges.

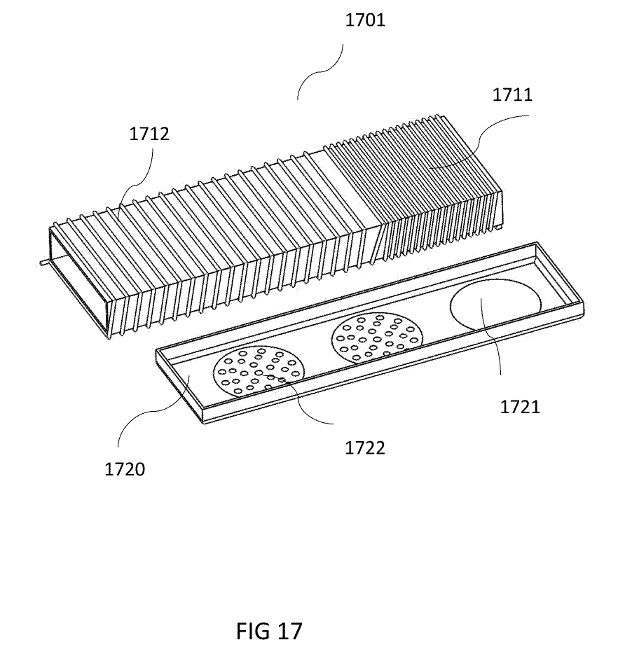

In a burger cooking operation, there is also a need to warm up bread used as a burger bun. Induction heating tunnel depth can be lengthened to hold a long food-heating induction cartridge that has a place for a burger and a bun. For example, FIG. 17 shows a burger-heating induction cartridge 1720 that has a five-inch width sufficient for a burger patty, and has a fifteen-inch depth, sufficient for one burger patty 1721 and two bun halves 1722. Burger-heating induction cartridge 1720 is placed for cooking in induction heating tunnel 1710 of an induction cooking device 1701. Within burger-heating induction cartridge 1720, a heating pad 1711 is a solid piece used for heating burger patty 1721, and a heating pad 1712 is more porous and used to heat two bun halves 1722. Heat generated from heating pad 1712 will be less so that two bun halves 1722 are heated at a lesser temperature than burger patty 1721. Current wire density variation of induction heating tunnel 1710 is also used in combination with the patty pad porosity difference to obtain the temperature differential. That is, current wire density is higher in a location where burger patty 1721 is to be heated and lower where two bun halves 1722 are to be heated so that heating power is greater for burger patty 1721 than for two bun halves 1722.

For example, pointy stubs on an induction heating pad on a food-heating induction cartridge and/or on a lid can be used to push into the meat to allow faster heat up of thicker portions of meet. The plates on the food-heating induction cartridge can be coated with non-stick coating for easy use.

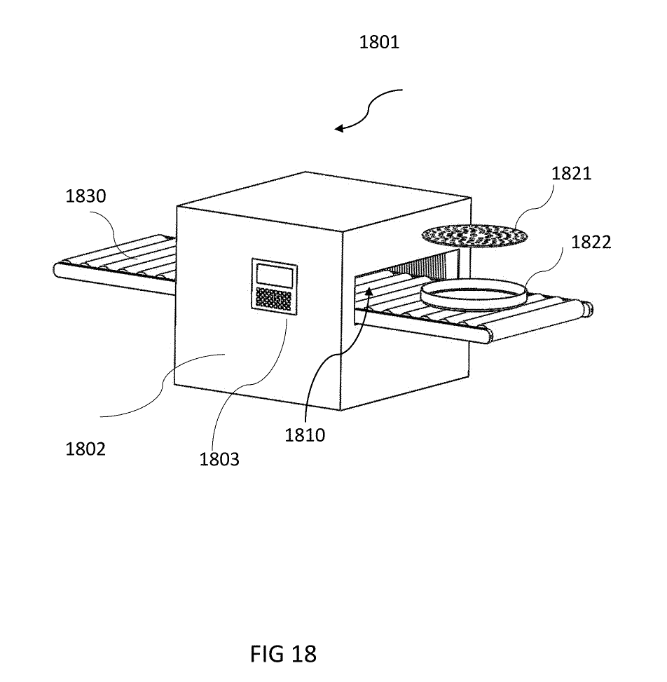

A pizza-heating induction cartridge can use a conveyor belt induction oven as shown in FIG. 18. An induction heating tunnel 1810 is built into a conveyor belt induction oven 1801. A conveyor 1830 carries a pizza within a pizza pan 1822 through a cooking area within induction heating tunnel 1810 located inside a case 1802. For example, induction heating tunnel 1810 is constructed with current coils winding around induction heating tunnel 1810. A control unit 1803 provides induction current to coil in the induction heating tunnel to heat up pizza pan 1822 to cook the pizza via direct contact from the bottom of the pizza. The bottom plate of pizza pan 1822 made of grade 430 stainless steel that is capable of induction heating. Pizza dough with the topping is placed on pan 1822. A top heating plate 1821 is placed at a set distance from the bottom of pan 1822 so that top heating plate 1821 does not have contact with the pizza topping. The heating of top heating plate 1821 by induction magnetic field will emit infrared radiation. The heating to the topping of the pizza is via the radiant heat from the top plate. An air flow control system directs air flow downward toward top heating plate 1821 passing through holes in top heating plate 1821, gaining thermal energy to impinge on the top of the pizza. Alternatively, top heating plate 1821 can have a parallel fin array, with the fin length along the direction of the conveyor movement. The edges of the fins point upward and downward. Alternatively, concentric rings of fins can be used. Alternatively, the top heating plate can be stationary and affixed inside the tunnel extending from the entrance to exit of the tunnel. Air flow downward will pick up thermal energy from the fins and impinge on the pizza to facilitate the cooking. By the time the conveyor belt carries pan 1822 from an entrance of induction heating tunnel 1810 to the exit of induction heating tunnel 1810, the pizza is cooked. It is preferable to balance the power intensity from the bottom and from the top to optimize the pizza dough doneness, without overly drying up the topping. A typical temperature is one hundred and fifty degrees Fahrenheit.

A conveyor belt induction oven can also be able cook flat bread and taco bread and pan cake type of food using a simple cartridge composed of two flat plates.

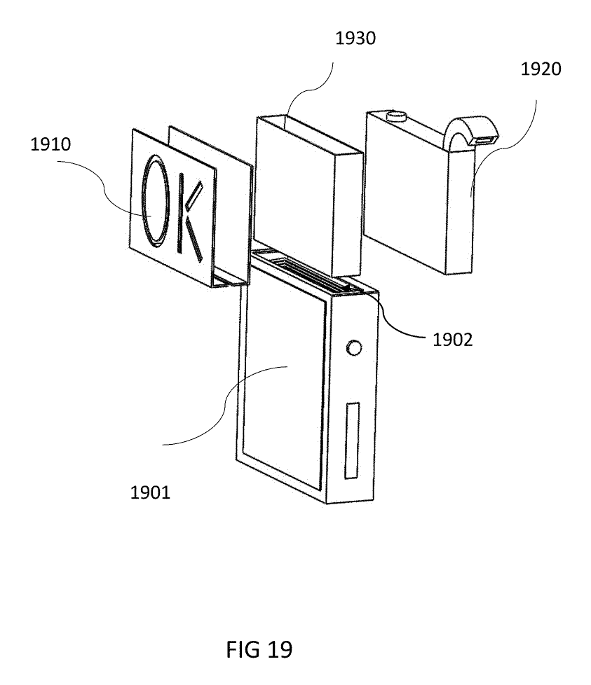

FIG. 19 shows an induction oven composed of a case 1901 and an induction heating tunnel 1902 with a current coil ready to receive different food-heating induction cartridges. Different food-heating induction cartridges are used for different types of foods. A control pad on case 1901 is used to control a temperature profile used to cook the food.

For example, a bread cartridge 1910 is used to hold a slice of bread or a bagel. For example, bread cartridge 1910 includes a pair of induction metal plates, a gap between the plates is designed to be adjustable so that in operation the gap is set to be slightly smaller than the thickness of the bread so that the plates are in contact with the bread during cooking. The pair of metal plates can be, for example, hinged steel plates. The gap between the plates is designed to the thickness of the bread or slightly smaller than the thickness of the bread so that the plates are in contact with the bread during cooking. Alternatively, bread cartridge 1910 is designed to be spring loaded to ensure contact with the bread. Because the induction heating plates are in contact with bread, it is possible to have engraving of graphic, text message on the plates so that the message or pattern will be toasted on the bread. The metal plates can be stamped to some patterned protrusions from the flat surface to make strong contact with the bread. Alternatively, a patterned cut out or recession can be used that results in a pattern on the cooked food item. For example, the pattern can be a logo of the hotel where a toaster is used for the continental breakfast. Or a greeting message to someone when making toast in the morning. It is a great gift product to offer personalized messages or images on toaster plates.

FIG. 19 also shows a water bottle 1920 in a rectangular shape used as food-heating induction cartridge that fits in the opening of the induction heating tunnel 1902. Using induction cooking to heat water can be faster and more efficient that using traditional cookware to heat water. For a given volume of the water, the surface area of water bottle 1920 is larger on the rectangular shape than for a cylindrical shaped cookware.

FIG. 19 also shows an instant noodle container 1930. Noodles fit in the rectangular shape of instant noodle container 1930. The configuration provides a quick heat-up time to heat water to near boil or boiling. The control unit on case 1901 provides a temperature profile that results in cooking noodles. When the noodles are done, a signal either of light or sound alerts an operator that the meal is ready. For example, it is possible to have a single multi-function food-heating induction cartridge that can be used to heat tea, water, noodles and even rice. A sealed unit can be pressurized to some degrees to speed up the cooking even further. And such a sealed unit can be used as a lunch box to bring to work daily.

A sensing control is used to sense when a food-heating induction cartridge is inserted into an induction heating tunnel, so that the heating power is automatically on. Alternatively, power to an induction heating tunnel is switched on manually.

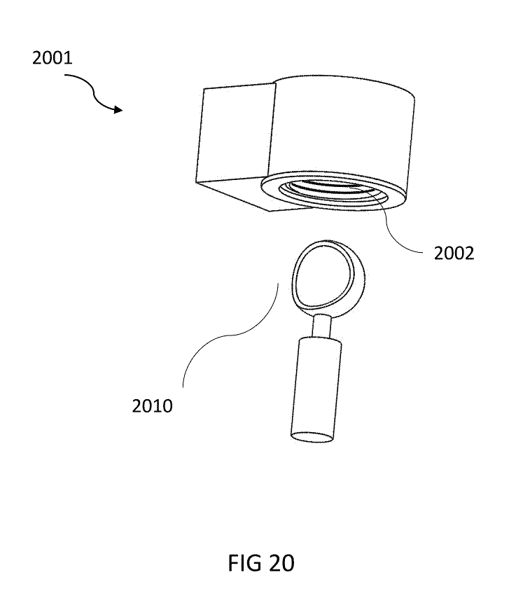

FIG. 20 shows a wall mount induction heater 2001 with an induction heating tunnel 2002 that has a circular opening. Wall mount induction heater 2001 is used as a utensil heater to heat induction sensitive utensils. For example, a control circuit senses insertion of a steel item. An ice scream scoop 2010 made of stainless steel utilizes is heated up by wall mount induction heater 2001 before being used to scoop ice scream. Wall mount induction heater 2001 can also be configured to heat up a knife before cutting butter or heat up a heat pop openable seal of a water bottle or sealed container, or other wax melting applications.

The foregoing discussion discloses and describes merely exemplary methods and implementations. As will be understood by those familiar with the art, the disclosed subject matter may be embodied in other specific forms without departing from the spirit or characteristics thereof. Accordingly, the present disclosure is intended to be illustrative, but not limiting, of the scope, which is set forth in the following claims.

What is claimed is:

1. An induction cooking device comprising:
an induction heating tunnel including:
a frame defining boundaries of a tunnel opening, and
an induction coil assembly that includes induction wire wound to form a parallel current array on a top and a bottom of the frame; and,
a food heating induction cartridge into which food is placed for heating.

2. An induction cooking device as in claim 1, wherein food-heating induction cartridge includes a thermal couple installed on a plate.

3. An induction cooking device as in claim 1, wherein the food heading induction cartridge is configured to hold a liquid.

4. An induction cooking device as in claim 1, additionally comprising:
an electronic control unit that controls temperature within the food heating induction cartridge in accordance with a power verses time cooking time profile.

5. An induction cooking device as in claim 1, wherein the food heating induction cartridge is rotated within the induction heating tunnel.

6. An induction cooking device as in claim 1, additionally comprising:
a fan and a filter configured to extract food fumes from the induction heating tunnel.

7. An induction cooking device as in claim 1, wherein induction heating tunnel is configured to begin a heating process when the food heading induction cartridge is detected entering the induction heating tunnel.

8. An induction cooking device as in claim 1, wherein a geometry of a magnetic heating element of the food heating induction cartridge is selected to obtain temperature uniformity over food contacting areas of the food heating induction cartridge.

9. An induction cooking device as in claim 1:
wherein the induction heating tunnel is within an array of induction heating tunnels, each induction heating tunnel in the array of induction heating tunnels being sized to receive a burger-heating induction cartridge configured to fit a burger patty and two bun halves; and,
wherein the burger-heating induction cartridge includes a first heating pad used for heating the burger patty, and a more porous heating pad to heat the two bun halves.

10. An induction cooking device as in claim 1:
wherein the induction heating tunnel is within an array of induction heating tunnels, each induction heating tunnel in the array of induction heating tunnels being sized to receive a burger-heating induction cartridge configured to fit a burger patty and two bun halves; and,
wherein for each induction heating tunnel in the array of induction heating tunnels, current wire density is higher in a location where the burger patty is to be heated and lower where the two bun halves are to be heated.

11. An induction cooking device as in claim 1 wherein the food heating induction cartridge includes a plurality of induction heating pads used to heat multiple pieces of food.

12. An induction cooking device as in claim 1, additionally comprising:
a conveyer belt for conveying the food heating induction cartridge through the induction heating tunnel.

13. An induction cooking device as in claim 1, wherein the food heading induction cartridge is configured to heat noodles.

14. An induction cooking device as in claim 1, wherein the food heading induction cartridge include a pair of metal plates between which bread is placed, at least one of the metal plates including patterned protrusions or recessions from a flat surface configured to make strong contact with the bread and leave a predetermined pattern on the bread.

15. An induction heating oven, comprising:
an induction heating tunnel including:
a frame defining boundaries of a tunnel opening, and
an induction coil assembly that includes induction wire wound to form a parallel current array on a top and a bottom of the frame; and,
a food heating induction cartridge into which food is placed for heating.
a conveyer belt for conveying the food heating induction cartridge through the induction heating tunnel.

16. An induction heating food cartridge, comprising:
a first piece that includes a first induction heating pad used to heat food when the induction heating food cartridge is placed within an induction heating tunnel; and
a second piece that includes a second induction heating pad used to heat the food when the induction heating food cartridge is placed within the induction heating tunnel;
wherein the food is held between the first piece and the second piece.

17. An induction heating food cartridge as in claim 16, wherein the first induction heating pad and the second induction heating pad each consists of an array of pads.

18. An induction heating food cartridge as in claim 16, wherein the first is a pan and the second piece is a lid for the pan.

19. An induction heating food cartridge as in claim 16, wherein the first induction heating pad has a first pattern of perforations selected to achieve uniform heating under influence of an alternative magnetic field and wherein the second induction heating pad has a second pattern of perforations selected to achieve uniform heating under influence of an alternative magnetic field.

20. An induction heating food cartridge as in claim 16, wherein first piece and the second piece are connected by a hinge.

21. An induction heating food cartridge as in claim 16, wherein first piece includes a handle.
